(19) United States
(12) Patent Application Publication
(10) Pub. No.: US 2016/0229162 A1
(43) Pub. Date: Aug. 11, 2016

(54) CONCRETE CURING BLANKET

(71) Applicant: KING FAHD UNIVERSITY OF PETROLEUM AND MINERALS, DHAHRAN (SA)

(72) Inventors: FERAS MOHAMMAD ABDALLA KAFIAH, DHAHRAN (SA); HUSAM MOHAMMAD WAHID ABDEL LATIF WALWIL, DHAHRAN (SA); MOHAMMED AHMAD KHALIL, DHAHRAN (SA); FADI MOHAMMED ABU SAMRA, DHAHRAN (SA)

(21) Appl. No.: 14/620,139

(22) Filed: Feb. 11, 2015

(51) Int. Cl. B32B 27/30; B29C 35/02; B32B 27/12; B32B 27/08; B32B 27/32; B32B 5/02

(52) U.S. Cl. CPC B32B 27/308; B32B 27/32; B32B 5/024; B32B 27/12; B32B 27/08; B29C 35/0288; B32B 2250/03; B32B 2307/726; B32B 2307/412; B29L 2007/002

(57) ABSTRACT

An embodiment of a concrete curing blanket includes a top layer having a transparent material, an intermediate layer including an absorbent material and a water super-absorption polymer powder, and a bottom layer including a pervious fiber material, such as burlap. The polymer powder includes polymer chains which decompose upon exposure to sunlight. Water is absorbed in the intermediate layer and released to the bottom layer upon decomposing of the polymer chains. The bottom layer can contact the concrete surface when the blanket is positioned thereon. Water released from the intermediate layer passes through the bottom layer onto the concrete surface.

### BACKGROUND OF THE INVENTION

1. Field of the Invention

The present invention generally relates to concrete curing and, more particularly, to a multi-layered blanket for use in curing concrete.

2. Description of the Related Art

Concrete curing is a process that occurs after pouring concrete, to ensure that the concrete sets properly and attains the required strength necessary to avoid cracking. The curing period typically lasts for 28 days, the first seven (7) of which are the most critical since approximately 60% to 70% of the concrete's compression strength is attained during this period. To properly cure concrete, it should be kept moist during the first seven (7) days of the curing period. Failing to keep the concrete moist can reduce the strength of the concrete and, thereby, lead to cracking. Repairing of cracks generally requires special materials and extensive labor, resulting in unnecessary expenditures of time and money.

Currently, there are several methods being used to cure concrete, including, directly sprinkling water on the concrete, covering the concrete with a saturated wet covering, covering the concrete with plastic sheets and coated paper, and applying curing compounds to the concrete surface. Direct sprinkling (a.k.a fogging) of water over the initially poured concrete cannot guarantee 100% of curing because in an environment having high temperatures, such as in the region of Saudi Arabia, the water evaporates quickly causing the concrete to dry prematurely and leave behind concrete that has not undergone the full curing period. This will inhibit the strengthening process, as well as lead to discoloration of the concrete and cracking. To avoid these results, water can be sprinkled on the concrete continuously several times a day. This not only results in a waste of time and energy, but also unnecessarily consumes large amounts of water, which can be detrimental in areas or regions that experience water shortages.

A saturated wet covering can be used to cover the top of newly poured concrete. However, the saturated wet covering will, typically, not stay moist for the duration of the curing period (7 to 28 days) since high temperatures will normally cause the moisture to evaporate quickly. Further, the evaporation of water from the saturated wet covering will typically result in the concrete losing water since covering will absorb water from the concrete as the water is being evaporated from the wet covering instead of adding water to the concrete so that it may retain its moisture for the entire curing period. As such, sprinkling is needed to keep the covering saturated. This requires someone to constantly monitor the covering and spray water onto the covering so as to maintain its moisture. Further, the saturated wet covering normally requires additional support in order to prevent wind from removing the covering and is typically only good for a single use.

Using plastic sheets and coated paper can also be inadequate since, due to its impervious nature, plastic sheets and coated paper typically prevent the evaporation of water from the concrete. This can lead to discoloration of the concrete and inhibit the concrete from attaining the requisite strength.

The use of curing compounds is normally very labor intensive and expensive since the curing compounds, such as water-based compounds, resin-solvent based chlorinated rubber compounds, and wax based compounds, must be directly exposed to the concrete surface through rolling, brushing, or spraying. Further, not only must the surface of the concrete be cleaned carefully prior to the application of these compounds, but the compounds must be applied to the concrete within a strict time frame. It can also be extremely difficult to ensure that the entire surface of the concrete has been treated since the compounds are transparent and only applied in small quantities.

Thus, a concrete curing blanket solving the aforementioned problems is desired.

### SUMMARY OF THE INVENTION

An embodiment of a concrete curing blanket includes a top layer having a transparent material, an intermediate layer including an absorbent material and a water super-absorption polymer powder, and a bottom layer including a pervious fiber material, such as burlap. The polymer powder includes polymer chains which decompose upon exposure to sunlight. Water is absorbed in the intermediate layer and released to the bottom layer upon decomposing of the polymer chains. The bottom layer can contact the concrete surface when the blanket is positioned thereon. Water released from the intermediate layer passes through the bottom layer onto the concrete surface.

These and other features of the present invention will become readily apparent upon further review of the following specification and drawings.

### BRIEF DESCRIPTION OF THE DRAWINGS

FIG. 1 is an environmental, cross section view of an embodiment of a concrete blanket according to the present invention.

FIG. 2 is an illustration of an embodiment of a concrete blanket according to the present invention, with a portion of the blanket rolled up.

Similar reference characters denote corresponding features consistently throughout the attached drawings.

### DETAILED DESCRIPTION OF THE PREFERRED EMBODIMENTS

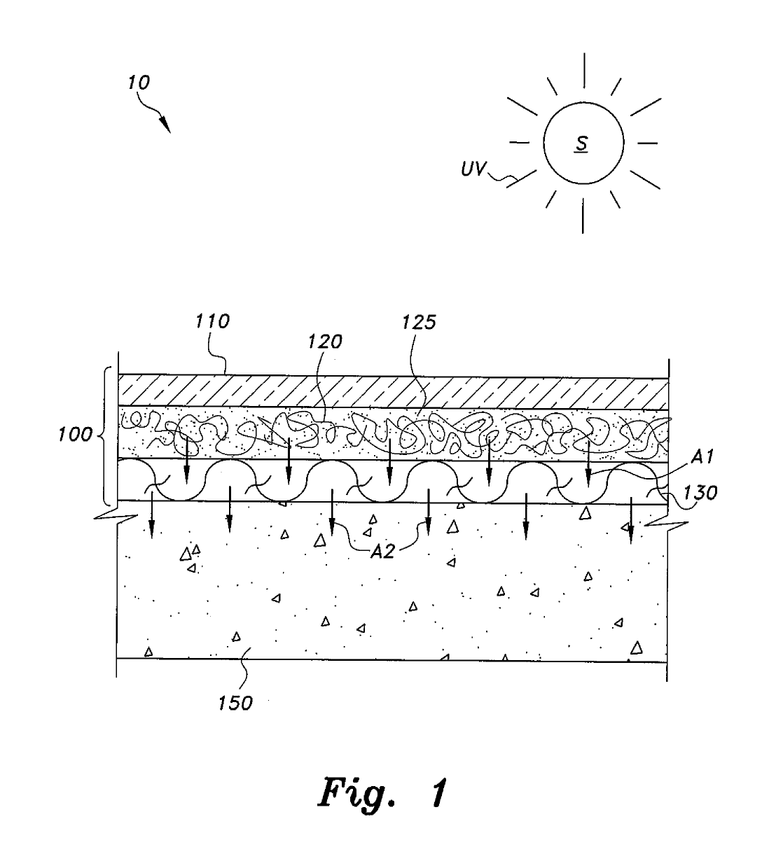

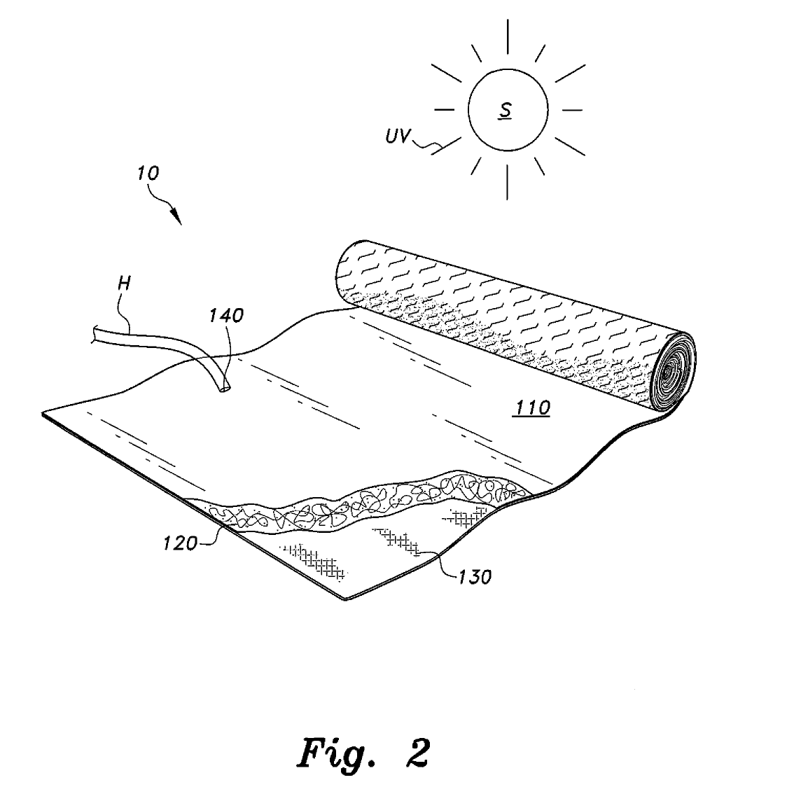

Referring to FIGS. 1 and 2, an embodiment of a concrete curing blanket 10 is generally illustrated. The concrete curing blanket 10 includes a plurality of layers 100, including a top layer 110 that is at least partially transparent, an absorbent intermediate layer 120, and a bottom layer 130 including a light-weight woven material. The absorbent intermediate layer 120 can include a water super-absorption polymer powder 125, such as sodium polyacrylate. The bottom layer 130 is configured to contact a newly poured concrete surface 150 when the concrete curing blanket 10 is positioned thereon. The concrete curing blanket 10 can be configured to include an opening 140 configured for receiving water, such as through a hose H.

The intermediate layer 120 of the concrete curing blanket 10 can have a high volumetric capacity and a high absorption capacity. The concrete curing blanket 10 can retain about 40 liters of water for every 1 m² in the intermediate layer 120. The intermediate layer 120 can absorb water instantly, e.g., within a couple of minutes, and also retain water for at least seven (7) days. Ultraviolet (UV) rays from the sun S can penetrate the top layer 110 and decompose polymer chains of the polymer powder 125 to allow water retained therein to travel through the bottom layer 130 and to wet a concrete surface.

The top layer 110 of the concrete curing blanket 10 can be formed from any suitable transparent material, such as from a polyethylene plastic material, that can permit penetration of ultraviolet (UV) rays from the sun S. The top layer 110 can be impervious and prevent evaporation of water. The intermediate layer 120 can be made from any suitable absorbent material, such as cotton. The bottom layer 130 of the concrete curing blanket 10 can be formed from any suitable fiber material or material woven from fibers, such jute, hemp or flax. A suitable fiber material can be burlap, for example. The bottom layer 130 can allow water to flow onto the concrete surface 150, as illustrated by the second arrows A2 in FIG. 1. The plurality of layers 100 of the concrete curing blanket 10 can be secured to one another by any suitable means. Further, the concrete curing blanket 10 can have any suitable shape, such as a generally rectangular, and can have any size suitable to cover a concrete surface 150.

Penetration of UV light to the intermediate layer 120 of the concrete curing blanket 10 can be controlled by modifying the level of transparency (i.e. opaqueness) of the top layer 110. For example, the more opaque (i.e. darker) the top layer 110 of the concrete curing blanket 10 is, the harder it can be for ultraviolet rays UV to penetrate the intermediate layer 120 and decompose the polymer chains of the water super-absorption polymer powder 125. This, in turn, can control the transfer of water to the underlying bottom layer 130, as illustrated by the first arrows A1 in FIG. 1.

By way of operation, a user first saturates the intermediate layer 120 with water by filling the concrete curing blanket 10 with water, such as by inserting the hose H into the opening 140 on the top layer 110. Once the water is absorbed by the water super-absorption powder 125 within the intermediate layer 120, the bottom layer 130 of the concrete curing blanket 10 is positioned in continuous communication relation with the concrete surface 150, such as on top of the concrete surface 150 and, preferably, in a location where the top layer 110 is exposed to ultraviolet rays UV for at least seven (7) days. During the at least seven (7) days of the curing period, ultraviolet rays UV from the sun S can penetrate the intermediate layer 120 by passing through the top layer 110 of the concrete curing blanket 10 and decomposing the polymer chains of the water super-absorption powder 125. As a result, water can be released onto the bottom layer 130, as illustrated by the first arrows A1. Once the water is released onto the bottom layer 130, the water can pass across the bottom layer 130 and onto the concrete surface 150, as illustrated by the second arrows A2, so as to maintain the concrete surface 150 wet/moist.

As discussed previously, the speed at which the polymer chains of the water super-absorption powder 125 decompose and release water onto the bottom layer 130 can be controlled by the level of transparency of the top layer 110. For example, the more transparent the top layer 110 the more ultraviolet rays UV penetrate the top layer 110 and make contact with the intermediate layer 120 and the quicker the polymer chains of the water super-absorption powder 125 decompose and release water onto the bottom layer 130, of the concrete curing blanket 10, as illustrated by the first arrows A1. On the other hand, the more opaque (i.e. darker) the top layer 110 of the concrete curing blanket 10 is, the fewer ultraviolet rays UV can penetrate the top layer 110 and make contact with the intermediate layer 120. This, in turn, can delay the speed with which the polymer chains of the water super-absorption powder 125 are decomposed and release water onto the bottom layer 130 of the concrete curing blanket 10. A gradual or slow release of water onto the bottom layer 130, results in a slow release of water onto the concrete surface 150. By regulating the water flow onto the concrete surface 150, the concrete curing blanket 10 can eliminate the need for rewetting the concrete surface 150 during the first seven (7) days of the curing period and, therefore, save water.

Further, the weight of the concrete curing blanket 10 can be controlled by the amount of water poured into the concrete curing blanket 10. This weight can ensure that the concrete curing blanker 10 will lie flat on the concrete surface 150. Further, the use of water to weigh down the concrete curing blanket 10 can eliminate the need to use additional support(s) to keep the concrete curing blanket 10 on the ground during the curing period.

It is to be understood that the present invention is not limited to the embodiments described above, but encompasses any and all embodiments within the scope of the following claims.

I claim:

1. A concrete curing blanket, comprising:
a top layer, the top layer being at least partially transparent;
an intermediate layer below the top layer, the intermediate layer including an absorbent material; and
a bottom layer below the intermediate layer, the bottom layer including a pervious material;
wherein the intermediate layer includes a water super-absorption polymer powder.

2. The concrete curing blanket according to claim 1, wherein the intermediate layer comprises cotton.

3. The concrete curing blanket according to claim 1, wherein the water super-absorption polymer powder comprises sodium polyacrylate.

4. The concrete curing blanket according to claim 1, wherein the bottom layer includes a fiber material.

5. The concrete curing blanket according to claim 4, wherein the fiber material comprises burlap.

6. The concrete curing blanket according to claim 1, wherein the top layer is impervious and includes an opening extending to the intermediate layer.

7. The concrete curing blanket according to claim 6, wherein the transparent material comprises a polyethylene plastic material.

8. A concrete curing blanket, comprising:
an intermediate layer including a water super-absorption polymer powder;
a top layer above the intermediate layer, the top layer including a transparent material configured for permitting ultraviolet rays to penetrate the intermediate layer; and
a bottom layer including a fiber material adapted for allowing water to flow onto a concrete surface;
wherein the top layer includes an opening that extends to the intermediate layer.

9. The concrete curing blanket according to claim 8, wherein the intermediate layer comprises cotton.

10. The concrete curing blanket according to claim 8, wherein the transparent material comprises a polyethylene plastic material.

11. The concrete curing blanket according to claim 8, wherein the fiber material comprises burlap.

12. A method of curing concrete, comprising the steps of:
providing a concrete curing blanket having an intermediate layer, the intermediate layer having a water super-absorption polymer powder; a top layer having a transparent material configured for permitting ultraviolet rays to penetrate the intermediate layer; and a bottom layer including a fiber material adapted for allowing water to flow onto a concrete surface from the intermediate layer;
saturating the intermediate layer of the concrete curing blanket; and
positioning the bottom layer of the concrete curing blanket on top of the concrete in a location where the top layer is exposed to UV rays.

13. The method of curing concrete according to claim 12, wherein the intermediate layer comprises cotton.

14. The method of curing concrete according to claim 12, wherein the water super-absorption polymer powder comprises sodium polyacrylate.

15. The method of curing concrete according to claim 12, wherein the transparent material comprises a polyethylene plastic material.

16. The method of curing concrete according to claim 12, wherein the fiber material comprises burlap.

17. The method of curing concrete according to claim 12, wherein the concrete curing blanket is maintained on top of the concrete for a period of about seven days.
